(19) United States
(12) Patent Application Publication
(10) Pub. No.: US 2005/0166243 A1
(43) Pub. Date: Jul. 28, 2005

(54) Digital real time interactive TV program system

(75) Inventors: Fu-Sheng Chiu, Taipei (TW); Chi-Yu Lai, Taipei (TW)

Correspondence Address: BACON & THOMAS, PLLC, 625 SLATERS LANE, FOURTH FLOOR, ALEXANDRIA, VA, 22314, US

(73) Assignee: ERA DIGITAL MEDIA CO., LTD., Taipei (TW)

(21) Appl. No.: 10/963,515

(22) Filed: Oct. 14, 2004

(30) Foreign Application Priority Data
Jan. 6, 2004 (TW) 093100223

(51) Int. Cl. H04N 7/08; H04N 7/52

(52) U.S. Cl. 725/93; 725/109

(57) ABSTRACT

The present invention is to provide a digital real time interactive TV program system comprising a codec for converting image and sound recorded in a studio into a real time digital AV signal and then sending it to at least one user end through a master. Each user end is adapted to send a user AV signal recorded at the user end to the master server. The master server is capable of selecting at least one user AV signal to combine with the real time digital AV signal and sending the combined signal to the codec. After the codec converts the combined signal into a real time digital interactive AV signal, the real time digital interactive AV signal is then sent to each user end through the master server, enabling a real time interactive screen comprising a real time screen region and a user real time screen region to be shown on the user end.

### FIELD OF THE INVENTION

The present invention relates to a digital interactive TV program system and more particularly to a digital real time interactive TV program system capable of selecting at least one user AV signal to combine with the real time digital AV signal and converting the combined user AV signal and the real time digital AV signal into a real time digital interactive AV signal, enabling the user end to show the screens of the selected user AV signal and the real time digital interactive AV signal at the same time and provide the real time digital interactive TV program.

### BACKGROUND OF THE INVENTION

The world we are living in has entered into a new era with information technology being progressed rapidly. All kinds of information products and peripherals are invented due to the fast progress in computer science and technology. The fast development of such new products not only brings a lot of convenience, but also is closely associated with our daily life and work. Moreover, due to the constant availability of a variety of advanced network and information products, network (e.g., the Internet) is now closely associated with our daily life. We can view network as the nervous system of society. Network can be employed in a wide variety of fields. Communication between one person and another person at a distal location is significantly facilitated over network. For example, in the past one person has to spent a lot of time and money to see friends or relatives by traveling a long distance. Nowadays, your image and voice can be sent to any place in the world by utilizing the multimedia feature of network in communication. As such, the internet has become dominant tool for data communication as we enters into an information age.

As stated above, not only traditional e-mail feature but only multimedia (i.e., any combination of text, pictures, sound, and video) are available over the Internet due to the booming thereof in recent years. If you have access to the Internet, you can retrieve information from millions of sources. Thus, many people spend some time in accessing to the Internet in their daily life. For coping with such trend, many network equipment manufacturers have produced a variety of advanced network products (e.g., cable modems, ADSL (Asymmetric Digital Subscriber Line), or the like) with high data transfer rate. Moreover, for brining more novel features to Internet access, some network equipment manufacturers have developed many different network peripheral devices including VolP (Voice Over IP Device). They are adapted to provide online communication service to consumers with a minimum charge for long distance or international call. Another network peripheral device is VoD (Video on Demand) which enables a person to select a desired movie from an image server and play the same immediately at any time of a day. Technology of VoD involves images and sound. Thus, VoD is particularly applicable to the media since VoD enables consumers to retrieve desired information in an interactive manner. It is anticipated that VoD will become more popular as time evolves.

In the current media, however, only a few number of channels have converted AV signals into digital TV signals so that a TV having a coupled set-up box may reproduce a high quality picture for viewing by reconverting the digital TV signals into electron beams. For most TV program production and broadcasting, they are still made by the conventional technology rather than by digital, interactive technology. As defined, an interactive mode of digital interactive service means a TV viewer can totally control the playing of a TV program. Further, a video game involving many persons, time programmed playing of movies, and long distance teaching are made possible simultaneously.

For example, currently a live program is recorded and broadcasted in a studio. Further, a viewer at a subscriber end may dial a call to the program for conversation with the host if call-in is allowed. However, neither one of the host in the studio, audience in the studio, and staff in the production control room can see the viewer at the subscriber end. As such, a good interaction among the host in the studio, audience in the studio, and the viewer is impossible. As a result, the call-in program may a low rating. Moreover, staff in the production control room cannot select desired viewers from many call-in viewers. As an end, the proceeding of program may be interfered adversely.

If a live program is conducted by the digital, interactive technology, not only staff in the production control room can effectively control the viewers in the subscriber ends but also images of the viewers can be sent to the studio while a real time conversation is making. As such, a good interaction is carried out among the host in the studio, the audience in the studio, and the viewers in the subscriber ends due to real time images and sound. As an end, the program can be well conducted. Thus, it is desirable to provide a digital, interactive service to TV viewers by the media in order to overcome the above drawback of the prior art.

### SUMMARY OF THE INVENTION

A primary object of the present invention is to provide a digital real time interactive TV program system comprising a codec for converting image and sound signals recorded by a camera and recorder assembly in a studio into a real time digital AV signal. The real time digital AV signal is then sent to a master server, which enables at least one user end to receive the real time digital AV signal and show a real time screen thereon. Moreover, each user end is adapted to send a user AV signal of the image and sound recorded by another camera and recorder assembly at the user end to the master server. The master server is capable of selecting at least one user AV signal to combine with the real time digital AV signal and sending the combined user AV signal and the real time digital AV signal to the codec. The codec is adapted to convert the combined user AV signal and the real time digital AV signal into a real time digital interactive AV signal which is in turn sent to the master server. The master server then sends the real time digital interactive AV signal to each user end. The user end is thus able to receive the real time digital interactive AV signal sent from the master server. Finally, a real time interactive screen is shown on the user end by reconverting the real time digital interactive AV signal into electron beams. By utilizing the present invention, the above drawback of the prior art can be overcome.

The above and other objects, features and advantages of the present invention will become apparent from the following detailed description taken with the accompanying drawings.

### BRIEF DESCRIPTION OF THE DRAWINGS

FIG. 1 presents schematically the connection according to a first preferred embodiment of the invention;

FIG. 2 shows a real time screen according to the first preferred embodiment of the invention;

FIG. 3 shows a real time interactive screen according to the first preferred embodiment of the invention;

FIG. 4 presents schematically the connection according to a second preferred embodiment of the invention;

FIG. 5 is a block diagram of master server according to the invention;

FIG. 6 is a table showing user database according to the invention;

FIG. 7 is a table showing user state table according to the invention;

FIG. 8 is a table showing user identification database according to the invention;

FIG. 9 is a flow chart showing a sequence of steps performed by the master server, the slave servers and the user ends according to the invention;

FIG. 10 shows a real time interactive screen according to the second preferred embodiment of the invention;

FIG. 11 presents schematically the components in a user end according to the invention; and

FIG. 12 presents schematically the connection according to a third preferred embodiment of the invention.

### DETAILED DESCRIPTION OF THE PREFERRED EMBODIMENTS

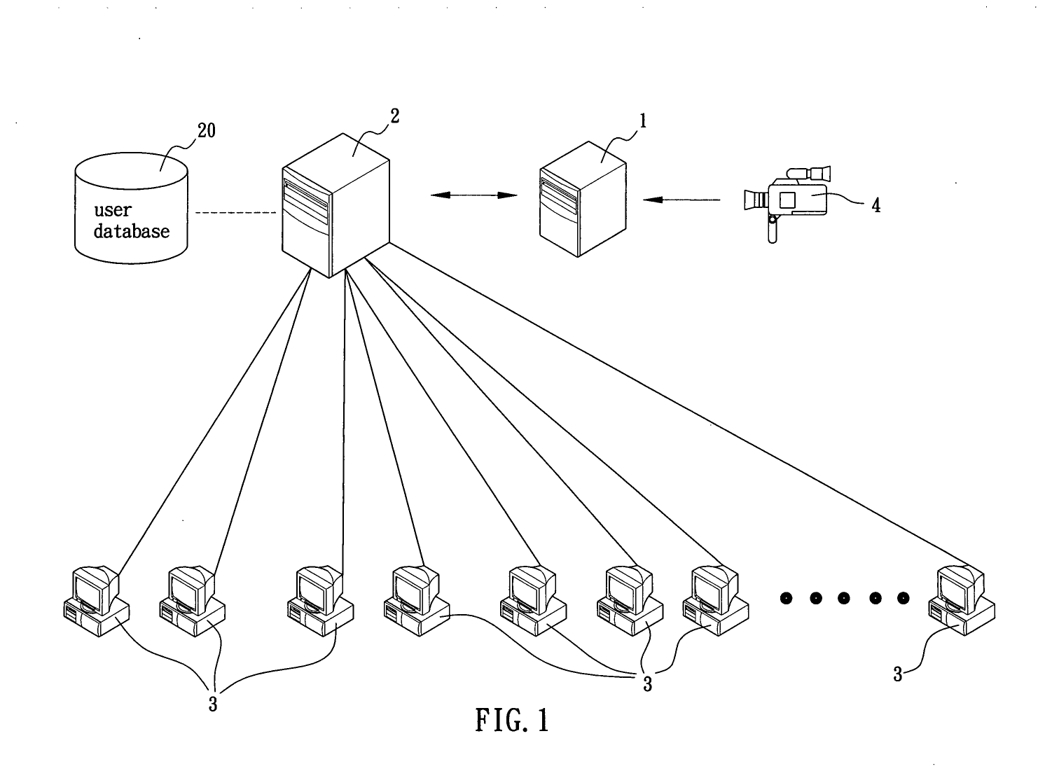

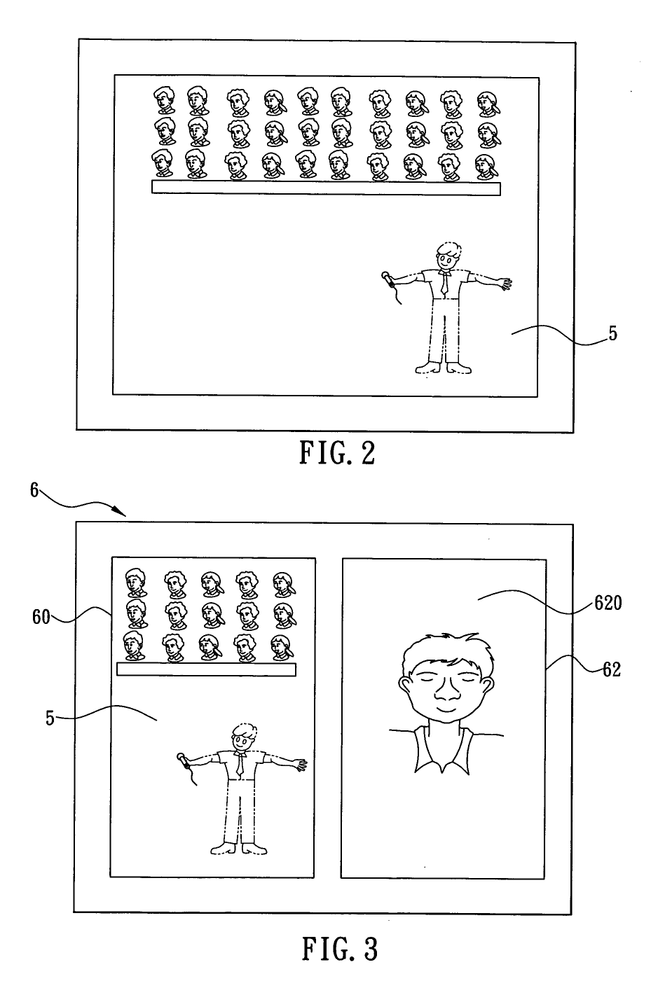

Referring to FIG. 1, there is shown a digital real time interactive TV program system in accordance with the invention comprising a codec (coder/decoder) 1, a master server 2, and at least one user end 3. The codec 1 is adapted to convert image and sound signals recorded by a camera and recorder assembly 4 in a studio into a real time digital AV (audio and video) signal and then is adapted to send the real time digital AV signal to the master server 2 for further processing. Each user end 3 is adapted to send a user AV signal of the image and sound recorded by another camera and recorder assembly at the user end 3 to the master server 2, and is able to receive the real time digital AV signal sent from the master server 2 and then show a real time screen 5 on the user end 3 by reconverting the real time digital AV signal into electron beams (see FIG. 2). At this moment, a viewer can see the image and hear the sound recorded by the camera and recorder assembly 4 from the real time screen 5.

After the master server 2 selecting at least one user AV signal to combine with the real time digital AV signal, the master server 2 may send the combined user AV signal and the real time digital AV signal to the codec 1. Next, the codec 1 converts the combined user AV signal and the real time digital AV signal into a real time digital interactive AV signal which is in turn sent to the master server 2. At this moment, the master server 2 sends the real time digital interactive AV signal to each user end 3. While the user end 3 receives the real time digital interactive AV signal sent from the master server 2, a real time interactive screen 6 is then shown on the user end 3 by reconverting the real time digital interactive AV signal into electron beams (see FIG. 3). The real time interactive screen 6 comprises a real time screen region 60 and a user real time screen region 62. As such, the viewer of the user end 3 can see both the real time screen 5 in the real time screen region 60 and a user real time screen 620 in the user real time screen region 62 in which the user real time screen 620 is formed by reconverting the user AV signal selected by the master server 2 into electron beams.

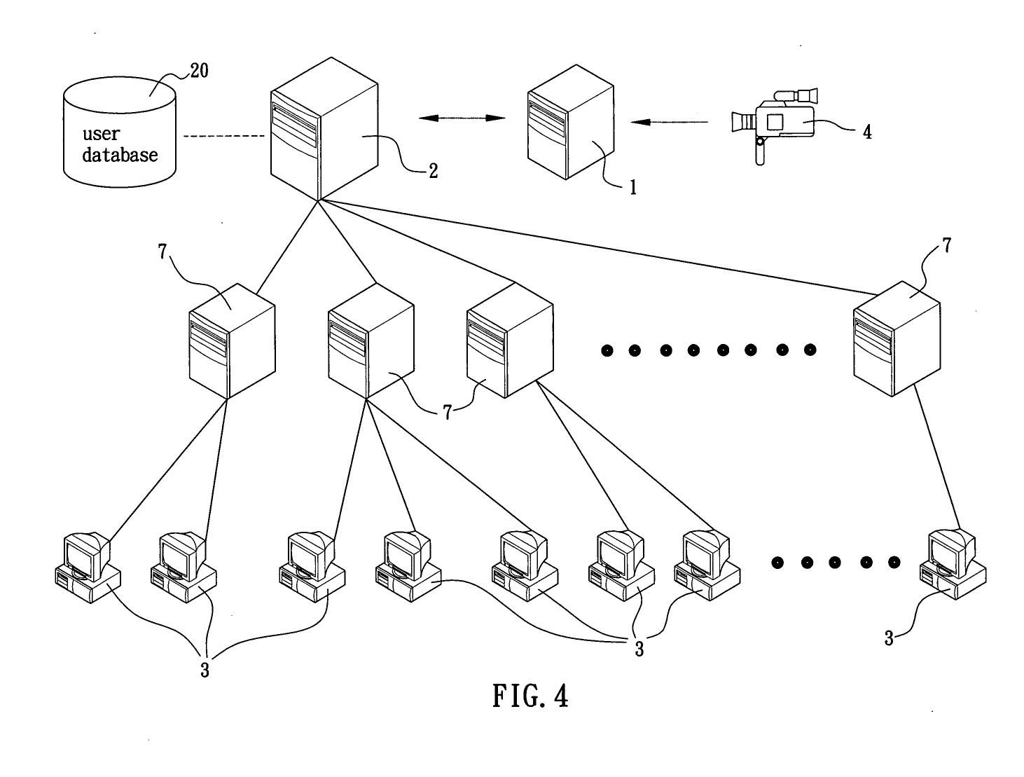

Currently, it is often that several ten thousand or even several hundred thousand viewers are watching a TV program at one time. This is particularly true for prime-time programs or special programs in which it is possible that a million viewers are watching a TV program. The viewer described above can be viewed as the user end 3 when the digital real time interactive TV program system of the invention is embodied. Hence, the master server 2 may be coupled to several ten thousand, several hundred thousand, or even a million user ends 3 in one time. As such, the load on the master server 2 can be too heavy for it to effectively transmit data to the user ends 3. For avoiding the above heavy load and low data transmission problems due to excessive network connections, a second preferred embodiment of the invention as shown in FIG. 4 is provided. As shown, a plurality of slave servers 7 are provided in which each slave server 7 is interconnected the master server 2 and at least one user end 3. The slave server 7 is adapted to send the user AV signal received from the user end 3 to the master server 2 for further processing. Also, the slave server 7 is adapted to receive the real time digital AV signal from the master server 2. The real time digital AV signal is again sent to the user end 3. A real time screen 5 is then shown on the user end 3 by reconverting the real time digital AV signal into electron beams. Alternatively, the master server 2 may selectively receive at least one user AV signal from the slave server 7. Both the user AV signal and the real time digital AV signal are sent to the codec 1. The codec 1 is adapted to convert both the user AV signal and the real time digital AV signal into a real time digital interactive AV signal which is in turn sent to the master server 2. At this moment, the master server 2 sends the real time digital interactive AV signal to the slave servers 7 so that the user ends 3 may receive the real time digital interactive AV signal. A real time interactive screen is finally shown on the user end 3 by reconverting the real time digital interactive AV signal into electron beams.

In view of the above, in a case of a live program produced in a studio, the camera and recorder assembly 4 in the studio records image and sound signals. The recorded image and sound signals are then converted into a real time digital AV signal by the codec 1. The real time digital AV signal is in turn sent to each user end 3 via the master server 2 and the slave servers 7. Next, a real time screen 5 is shown on the user end 3 by reconverting the real time digital AV signal into electron beams. As an end, a viewer can see image and hear sound by watching the TV program.

Moreover, each user end 3 may send a user AV signal of the image and sound recorded by another camera and recorder assembly at the user end 3 to the master server 2 via the slave server 7 so that the master server 2 and the codec 1 may convert both the user AV signal and the real time digital AV signal into a real time digital interactive AV signal. A real time interactive screen 6 is then shown on the user end 3 by reconverting the real time digital interactive AV signal into electron beams. At this moment, the host of a live program is able to conduct a conversation with a user end 3 corresponding to the user AV signal selected by the master server 2 in a real time AV mode. By utilizing this, it is possible of eliminating the drawback of telephone conversation between the host and a TV viewer as experienced in the prior art.

Also, the user AV signal and associated data are sent from the user end 3 to the slave server 7 rather than the master server 2 directly. Further, the master server 2 receives the user AV signal from a slave server 7 corresponding to a user end 3 after selecting the user end 3. Such distributed architecture can lessen the load of receiving the user AV signal or information from the user ends 3 on the master server 2. As known that a wide bandwidth was required for enabling the master server 2 to cope with the communication with the user ends 3. Advantageously, by utilizing the above technique of the invention, a network is established to connect the user ends 3, the slave servers 7, and the master server 2 together. The slave server 7 is thus able to receive user AV signals from its coupled user ends 3 and the master server 2 is simply coupled to the slave servers 7. Further, the master server 2 receives the user AV signal from the slave server 7 only if desired, resulting in a load reduction on the master server 2.

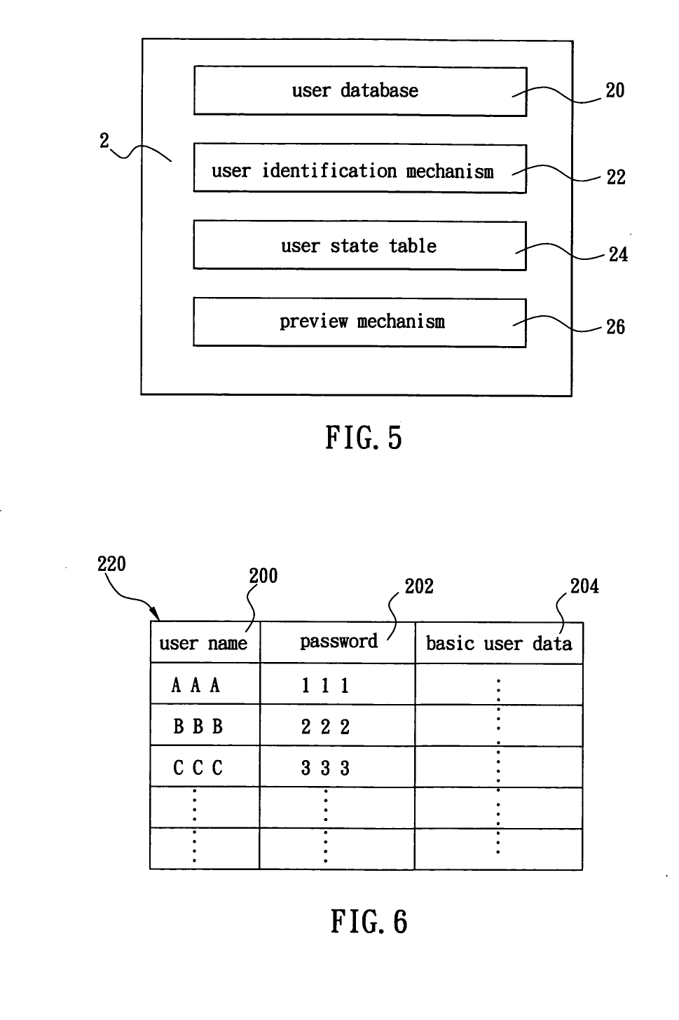

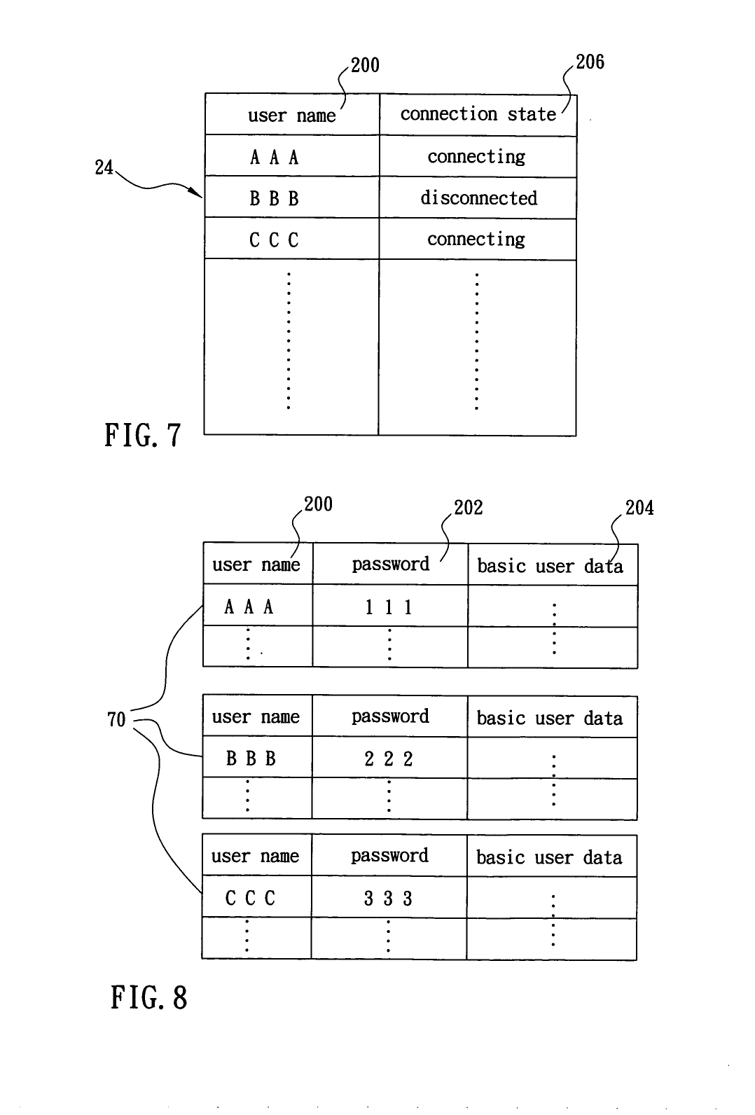

Referring to FIGS. 5 to 7, in the embodiment the master server 2 further comprises a user database 20, a user identification mechanism 22, and a user state table 24. The user database 20 comprises a plurality of records each including a user name 200, a password 202, and basic user data 204 of a user (see FIG. 6). The user state table 24 is established based on the user database 20 and is adapted to represent the connection states of the user ends 3. The user state table 24 comprises a plurality of records each including a user name 200 and a connection state 206 of a user (see FIG. 7). For sending a user AV signal from the user end 3 to the master server 2, the user end 3 is required to connect to the master server 2. After connecting, the master server 2 will activate the user identification mechanism 22 so as to request the user end 3 to type a user name and a password. After the user end 3 finishing the user name 200 and password 202 input and being identified by the user database 20 as correct, the user AV signal can be sent from the user end 3 to the master server 2. At the same time, the master server 2 can update the user state table 24 by changing the state of the user end 3 as a state of connecting.

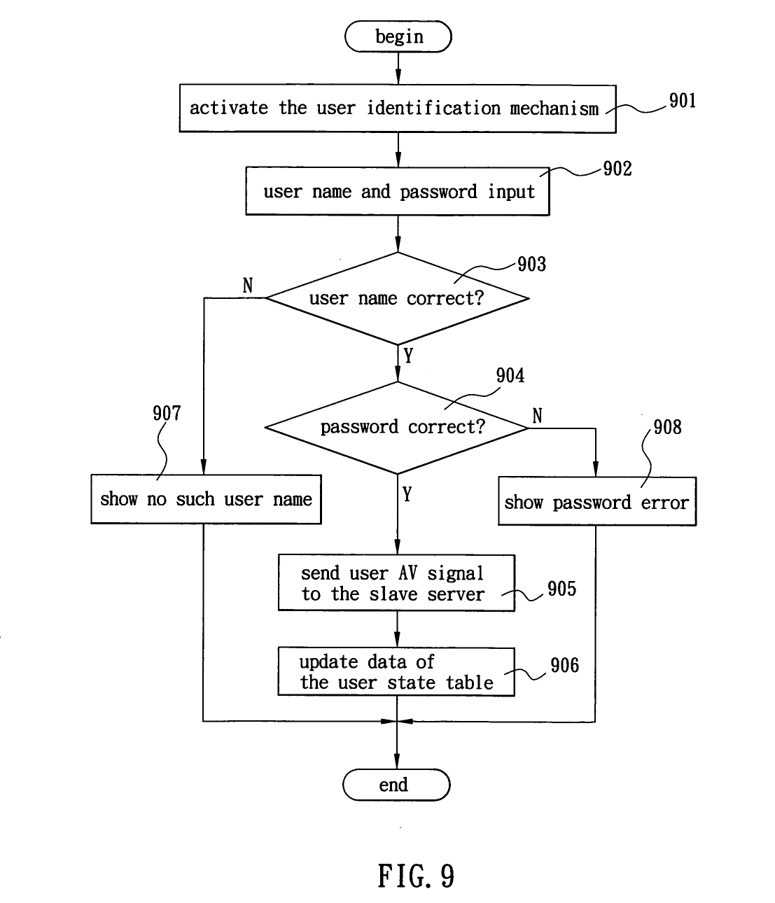

In a second embodiment of the invention, the slave server 7 further comprises a user identification database 70 and the user identification mechanism 22. The user identification database 70 comprises at least one record each including a user name 200, a password 202, and basic user data 204 of a user (see FIG. 8). The master server 2 comprises the user database 20 and the user state table 24. The user database 20 is established based on the user identification database 70. The user state table 24 is established based on the user database 20 and is adapted to represent the connection states of the user ends 3. The user state table 24 comprises a plurality of records each including a user name 200 and a connection state 206 of a user (see FIG. 7). For sending a user AV signal from the user end 3 to the slave server 7 such that the master server 2 can select the user AV signal of the user end 3, and then the master server 2, the slave server 7, and the user end 3 may perform a plurality of method steps as illustrated in the flow chart of FIG. 9 as below.

In step 901, the slave server 7 first sends information regarding user AV signal for activating the user identification mechanism 22 as requested by the user end 3.

In step 902, the slave server 7 requests the user end 3 to type a user name and a password thereof as required by the user identification mechanism 22.

In step 903, the system searches the user identification database 70 for determining whether there is a user name 200 the same as the input user name 200 in step 902. If yes, the process goes to step 904. Otherwise, the process jumps to step 907.

In step 904, the system searches the user identification database 70 again for determining whether there is a password 202 the same as the input password 202 associated with the user name 200 in step 902. If yes, the process goes to step 905. Otherwise, the process jumps to step 908.

In step 905, the user end 3 is permitted to send its user AV signal to the slave server 7 and in turn information regarding a correct identification of the user end 3 is sent to the master server 2.

In step 906, in response to input information regarding a correct identification of the user end 3, the master server 2 updates data of the user end 3 in the user state table 24 by changing the state of the user end 3 as a state of the user end 3 being connected to the slave server 7.

In step 907, a message of no such user name is shown on the user end 3.

In step 908, a message of password error is shown on the user end 3.

In view of the above, the master server 2 is aware of the connection state between the user end 3 and its corresponding slave server 7 rather than directly receives user AV signal and other information from the user end 3. In fact, each slave server 7 is adapted to receive user AV signal and other information from associated user ends 3. As a result, the load on the master server 2 is reduced significantly.

In the embodiment, in response to input information regarding a correct identification of the user end 3, the master server 2 updates data of the user end 3 in the user state table 24 by changing the state of the user end 3 as a state of the user end 3 being connected to the slave server 7. Thereafter, the master server 2 is able to select the user AV signal representing the connection of the slave server 7 and the user end 3 from the user state table 24. The selected user AV signal and the user AV signal are sent to the codec 1 for converting into a real time digital interactive AV signal. The real time digital interactive AV signal is then sent to the master server 2. Next, the master server 2 sends the real time digital interactive AV signal to the slave server 7 such that the user end 3 may receive the real time digital interactive AV signal from the slave server 7. Finally, a real time interactive screen is shown on the user end 3 by reconverting the real time digital interactive AV signal into electron beams.

It is understood that user AV signal cannot be sent from the user end 3 to the master server 2 for selection via the slave server 7 if the slave server 7 coupled to the user end 3 is malfunctioned or disabled due to unknown reasons. Advantageously, in the embodiments in a case of the user end 3 disconnected from one slave server 7, the user end 3 is able to automatically search other slave servers 7 and will connect to a nearest slave server 7 or a slave server 7 having a maximum bandwidth. Thus, the user end 3 is able to continue to send its user AV signal after being identified as a correct one. As a result, the real time interactive screen will not be interrupted. Moreover, in the embodiments for enabling a preview of the content of the user AV signal prior to combining the user AV signal with the real time digital AV signal at the master server 2 a preview mechanism 26 is provided in the master server 2 (see FIG. 5). The preview mechanism 26 is adapted to prevent an ungraceful or inappropriate picture from being shown on the real time interactive screen. In detail, the master server 2 activates the preview mechanism 26 to monitor the content of the user AV signal. After the content of the user AV signal has been confirmed to comply with the regulations, both the user AV signal and the real time digital AV signal are sent to the codec 1 for further processing.

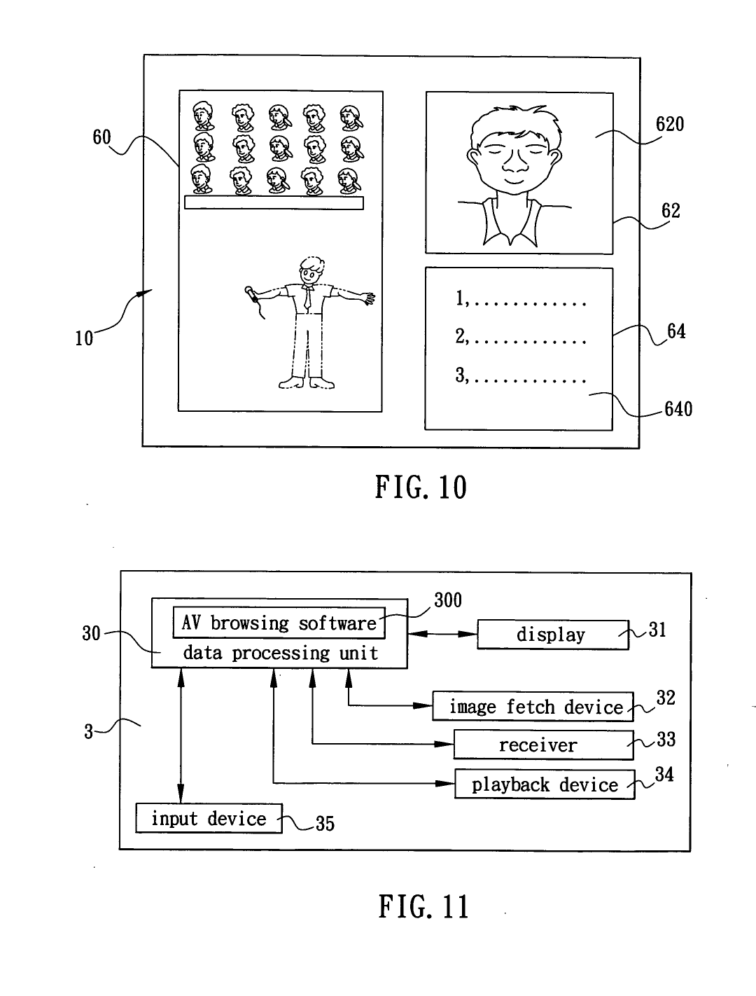

In addition, for enabling a user end 3 to see events such as raising a question, answering the question, operations, or the like from the real time interactive screen, in the embodiments the master server 2 further provides an information AV signal which together with the user AV signal and the real time digital AV signal are sent to the codec 1. The codec 1 then converts them into a real time digital interactive AV signal which is in turn sent to the master server 2. In response to receiving the real time digital interactive AV signal by the user end 3, another real time interactive screen 10 is shown on the user end 3 by reconverting the real time digital interactive AV signal into electron beams (see FIG. 10). Another real time interactive screen 10 comprises a real time screen region 60, a user real time screen region 62, and a real time information region 64. As such, the user end 3 can see the real time screen 5 in the real time screen region 60, a user real time screen 620 in the user real time screen region 62 in which the user real time screen 620 is formed by reconverting the user AV signal selected by the user end 3 into electron beams, and an information screen 640 in the user real time screen region 62 in which the information screen 640 is formed by reconverting the information AV signal provided by the master server 2 into electron beams. In such a manner, the user ends 3 are able to see events such as raising a question, answering the question, operations, or the like from the information screen 640 while an interactive program is being conducted.

Referring to FIG. 11, in the embodiments the user end 3 comprises a data processing unit 30 (e.g., computer or set-up box), a display 31, an image fetch device 32, a receiver 33, a playback device 34, and an input device (e.g., keyboard, mouse, or remote control) 35. The data processing unit 30 comprises an installed AV browsing software 300 for processing the real time digital AV signal and the real time digital interactive AV signal. Next, the real time screen 5, the real time interactive screen 6, and another real time interactive screen 10 are shown on the display 31. Further, the playback device 34 is adapted to play sound sent from the real time screen 5, the real time interactive screen 6, and another real time interactive screen 10. The user end 3 can fetch its user AV signal by means of the image fetch device 32. The receiver 33 is adapted to fetch a user voice signal from the user end 3. The user image signal and the user voice signal are processed to generate a user AV signal by the data processing unit 30. The user AV signal is then either sent to the master server 2 directly or sent to the master server 2 via the slave server 7. Moreover, the user end 3 may activate the input device 35 to type information (e.g., user name, password, and basic user data) required by the slave server 7.

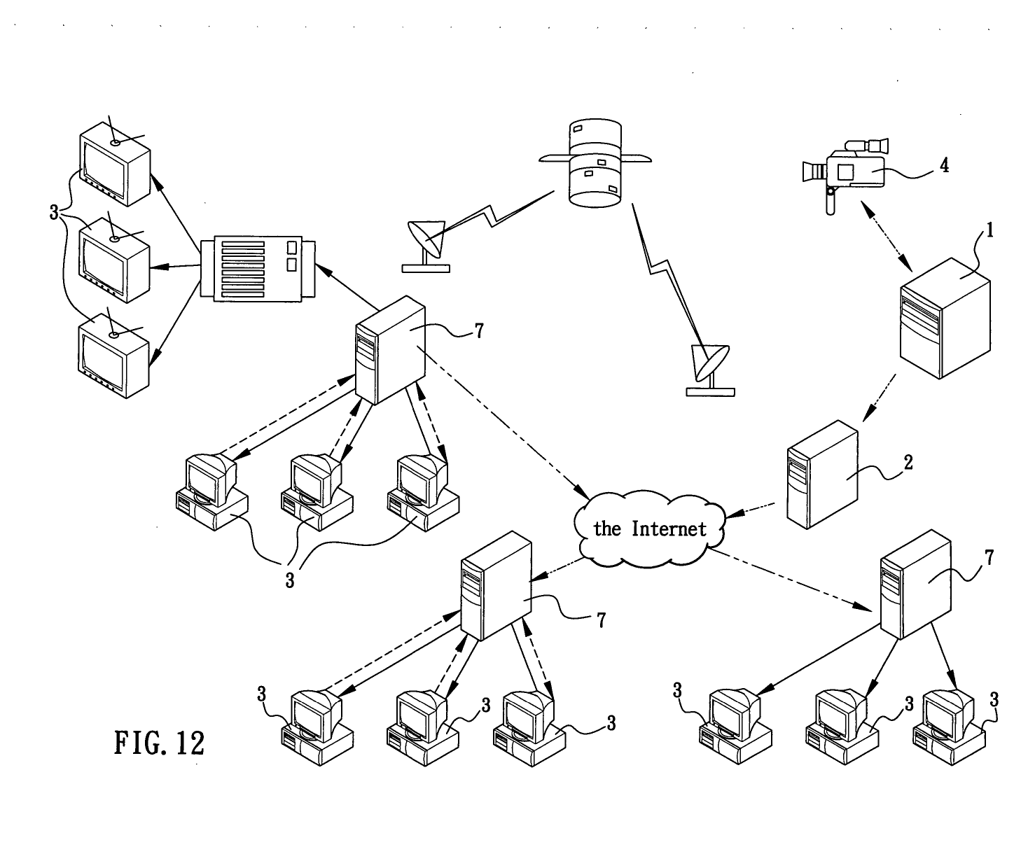

Referring to FIG. 12, in the embodiments a plurality of user ends 3 are coupled to a slave server 7 by a LAN (local area network), the Internet, a wireless network, a cable network, or a cable TV network. Moreover, a plurality of slave servers 7 are connected to the master server 2 by a LAN, the Internet, a wireless network, a cable network, a cable TV network, or a satellite. The user end 3 can be a computer, a cable TV, a digital TV, or the like.

While the invention has been described by means of specific embodiments, numerous modifications and variations could be made thereto by those skilled in the art without departing from the scope and spirit of the invention set forth in the claims.

1. A digital real time interactive TV program system, comprising a codec, a master server and at least one user end, wherein the codec is operative to convert image and sound signals recorded by a camera and recorder assembly in a studio into a real time digital AV signal and is operative to send the real time digital AV signal to the master server for further processing, and each user end is operative to send a user AV signal of the image and sound recorded by another camera and recorder assembly at the user end to the master server such that the master server, the codec and the user end are operative to perform the steps of:
enabling the master server to send the real time digital AV signal to the user end;
after receiving the real time digital AV signal, showing a real time screen on the user end in response to the real time digital AV signal wherein image and sound recorded by the camera and recorder assembly is played on the real time screen;
selectively combining at least one user AV signal with the real time digital AV signal by the master server and then sending the combined user AV signal and the real time digital AV signal to the codec;
converting the combined user AV signal and the real time digital AV signal into a real time digital interactive AV signal by the codec, and then sending the real time digital interactive AV signal to the master server; sending the real time digital interactive AV signal from the master server to the user end; and
after receiving the real time digital interactive AV signal by the the user end, showing a real time interactive screen on the user end in response to the real time digital interactive AV signal wherein the real time interactive screen comprises a real time screen region and a user real time screen region such that the user end is operative to see the real time screen in the real time screen region and a user real time screen in the user real time screen region with the user real time screen being formed by reconverting the user AV signal selected by the master server into electron beams.

2. The system of claim 1, further comprising a plurality of slave servers each interconnected the master server and the at least one user end wherein the slave server is operative to send the user AV signal received from the user end to the master server for further processing and receive the real time digital AV signal from the master server, the real time digital AV signal is sent to the user end, and a real time screen is shown on the user end by reconverting the real time digital AV signal into electron beams.

3. The system of claim 1, wherein the master server comprises:
a user database comprising a plurality of records each including a user name, a password, and basic user data of a user;
a user state table established based on the user database for representing a connection state of each user end, the user state table comprising a plurality of records each including a user name and a connection state of a user; and
a user identification mechanism wherein after connecting the user end to the master server, the master server activates the user identification mechanism for requesting the user end to type a user name and a password thereof, after the user end finishing the user name and the password input and being identified by the user database as correct, the user AV signal is sent from the user end to the master server, and at the same time, the master server is operative to update the user state table by changing a state of the user end as a state of connecting.

4. The system of claim 1, wherein the master server further comprises a preview mechanism such that the master server is operative to enable the preview mechanism to preview content of the user AV signal, and send the user AV signal and the real time digital AV signal to the codec for further processing.

5. The system of claim 1, wherein the master server provides an information AV signal which together with the user AV signal and the real time digital AV signal are sent to the codec, the codec converts the information AV signal, the user AV signal, and the real time digital AV signal into a real time digital interactive AV signal prior to sending to the master server, in response to receiving the real time digital interactive AV signal by the user end, a second real time interactive screen is shown on the user end by reconverting the real time digital interactive AV signal into electron beams, and the second real time interactive screen comprises a real time screen region, a user real time screen region, and a real time information region such that the user end is operative to see the real time screen in the real time screen region, a user real time screen in the user real time screen region wherein the user real time screen is formed by reconverting the user AV signal selected by the user end into electron beams, and an information screen in the user real time screen region wherein the information screen is formed by reconverting the information AV signal provided by the master server into electron beams.

6. The system of claim 1, wherein the user end comprises:
a data processing unit comprising an installed AV browsing software for processing the real time digital AV signal, the real time digital interactive AV signal, and a second real time interactive screen;
a display for showing the real time screen, the real time interactive-screen, and the second real time interactive screen after the AV browsing software having processed the real time digital AV signal, the real time digital interactive AV signal, and the second real time interactive screen;
playback means for playing sound sent from the real time screen, the real time interactive screen, and the second real time interactive screen;
image fetch means for fetching the user AV signal from the user end;
a receiver wherein the image fetch means fetches a user voice signal from the user end, the user image signal and the user voice signal are processed to generate a user AV signal by the data processing unit, and the user AV signal is sent to the master server; and
input means activated by the user end to input information required by the slave server.

7. The system of claim 1, wherein the user end is a computer, a cable TV, or a digital TV.

8. The system of claim 2, wherein the master server selectively receives at least one user AV signal from the slave server, the user AV signal and the real time digital AV signal are sent to the codec, the codec is operative to convert the user AV signal and the real time digital AV signal into a real time digital interactive AV signal prior to sending to the master server, and the master server sends the real time digital interactive AV signal to the slave servers so that the user end is operative to receive the real time digital interactive AV signal, and a real time interactive screen is shown on the user end by reconverting the real time digital interactive AV signal into electron beams.

9. The system of claim 2, wherein the slave server comprises the user identification database and the user identification mechanism, the user identification database comprises at least one record each including a user name, a password, and basic user data of a user, the master server comprises a user database and a user state table, the user database is established based on the user identification database, the user state table is established based on the user database for representing a connection state of each user end, and the user state table comprises a plurality of records each including a user name and a connection state of a user such that when the user end sends the user AV signal to the slave server the master server is operative to select the user AV signal of the user end, and the master server, the slave server, and the user end are operative to perform the steps of:
(a) enabling the slave server to send information regarding the user AV signal for activating the user identification mechanism as requested by the user end;
(b) enabling the slave server to request the user end to input a user name and a password thereof as required by the user identification mechanism;
(c) enabling the system to search the user identification database for determining whether there is a user name the same as the input user name;
(d) if the determination in step (c) is positive, enabling the system to search the user identification database for determining whether there is a password the same as the input password in step (b);
(e) if the determination in step (d) is positive, permitting the user end to send the user AV signal to the slave server and send information regarding a correct identification of the user end to the master server; and
(f) in response to the input information regarding a correct identification of the user end, enabling the master server to update data of the user end in the user state table by changing the state of the user end as a state of the user end being connected to the slave server.

10. The system of claim 2, wherein if the user end is disconnected from one of the slave servers, the user end is operative to automatically search the other slave servers and connect to a nearest one of slave servers or one of the slave servers having a maximum bandwidth such that the user end is operative to continue to send the user AV signal thereof after being identified as a correct one.

11. The system of claim 2, wherein the at least one user end is coupled to one of the slave servers for signal communication by a LAN, the Internet, a wireless network, a cable network, or a cable TV network.

12. The system of claim 2, wherein the slave servers are connected to the master server for signal communication by a LAN, the Internet, a wireless network, a cable network, a cable TV network, or a satellite.

13. The system of claim 3, wherein in response to the input information regarding a correct identification of the user end, the master server is operative to update data of the user end in the user state table by changing the state of the user end as a state of the user end being connected to the slave server, the master server is operative to select the user AV signal representing the connection of the slave server and the user end from the user state table, the selected user AV signal and the user AV signal are sent to the codec for converting into a real time digital interactive AV signal, the real time digital interactive AV signal is sent to the master server, the master server sends the real time digital interactive AV signal to the slave server, and the user end is operative to receive the real time digital interactive AV signal from the slave server such that a real time interactive screen is shown on the user end by reconverting the real time digital interactive AV signal into electron beams.

14. The system of claim 9, wherein in response to the input information regarding a correct identification of the user end, the master server is operative to update data of the user end in the user state table by changing the state of the user end as a state of the user end being connected to the slave server, the master server is operative to select the user AV signal representing the connection of the slave server and the user end from the user state table, the selected user AV signal and the user AV signal are sent to the codec for converting into a real time digital interactive AV signal, the real time digital interactive AV signal is sent to the master server, the master server sends the real time digital interactive AV signal to the slave server, and the user end is operative to receive the real time digital interactive AV signal from the slave server such that a real time interactive screen is shown on the user end by reconverting the real time digital interactive AV signal into electron beams.
